(19) United States
(12) Patent Application Publication
(10) Pub. No.: US 2016/0221404 A1
(43) Pub. Date: Aug. 4, 2016

(54) METHOD AND APPARATUS FOR MEASURING TIRE TREAD ABRASION

(71) Applicant: DAIN CO., LTD., Chungheongnam-do (KR)

(72) Inventors: Young Gi Lee, Chungcheongnam-do (KR); Kun Woo Lee, Seoul (KR); Seung Yeob Baek, Seoul (KR); Dong Uk Kam, Seoul (KR); Dae Wook Kim, Seoul (KR); Soo Gon Yoo, Seoul (KR)

(73) Assignee: DAIN CO., LTD., Chungheongnam-do (KR)

(21) Appl. No.: 14/941,332

(22) Filed: Nov. 13, 2015

(30) Foreign Application Priority Data
Jan. 29, 2015 (KR) 10-2015-0014600

(51) Int. Cl. B60C 99/00

(52) U.S. Cl. CPC B60C 99/006

(57) ABSTRACT

Provided are a method and an apparatus for measuring tire tread abrasion. The apparatus receiving a moving image of a tire, generates a three-dimensional (3D) image of the tire based on the moving image, and measures tire tread abrasion based on a depth of a tread area in the 3D image.

### CROSS-REFERENCE TO RELATED APPLICATION

This application claims the benefit of Korean Patent Application No. 10-2015-0014600, filed on Jan. 29, 2015, in the Korean Intellectual Property Office, the disclosure of which is incorporated herein in its entirety by reference.

### BACKGROUND

1. Field

One or more exemplary embodiments relate to a method and an apparatus for measuring tire tread abrasion, and more particularly, to a method and an apparatus for measuring tire tread abrasion by analyzing a moving image captured by a camera.

2. Description of the Related Art

Deep grooves are provided to a tire tread so as to enhance a braking force and a driving force. Since a tire tread directly contacts a surface of a road, as a driving distance increases, treads 1500 and 1510, shown in FIG. 15, are worn, and thus, a depth of a groove is reduced. Accordingly, a braking force deteriorates, and this affects safety. A driver may measure a depth of a tire tread, and if the depth of the tire tread is decreased, the driver needs to replace a tire. In a related art, a triangle mark is shown beside a tire tread in a related art, so as to easily indicate a time point when a tire is to be replaced.

However, a user may have to measure a depth of a tire and determine a point of time when the tire is to be replaced. Some drivers may not recognize a method of determining that a tire needs to be replaced due to a degree of abrasion of a tire tread.

### SUMMARY

One or more exemplary embodiments include a method and an apparatus for easily measuring tire tread abrasion based on a moving image of a tire tread that a user captured by using a camera.

Additional aspects will be set forth in part in the description which follows and, in part, will be apparent from the description, or may be learned by practice of the presented embodiments.

According to one or more exemplary embodiments, a method of measuring tire tread abrasion includes: receiving a moving image of a tire; generating a three-dimensional (3D) image of the tire based on the moving image; and measuring tire tread abrasion based on a depth of a tread area in the 3D image.

According to one or more exemplary embodiments, a method of measuring tread abrasion of a tire, the measuring being performed by a terminal includes: capturing a moving image that includes a tire tread area; transmitting the moving image to a server; and receiving information about tread abrasion of the tire from the server.

### BRIEF DESCRIPTION OF THE DRAWINGS

These and/or other aspects will become apparent and more readily appreciated from the following description of the embodiments, taken in conjunction with the accompanying drawings in which:

FIG. 1 illustrates a schematic configuration of a system for measuring tire tread abrasion according to an exemplary embodiment;

FIG. 2 is a block diagram of an abrasion measuring apparatus according to another exemplary embodiment;

FIG. 3 is a flowchart of an example of a method of measuring tire tread abrasion according to another exemplary embodiment;

FIG. 4 is a flowchart of an example of a method of generating a three-dimensional (3D) image by using a moving image so as to measure tire tread abrasion;

FIG. 5 illustrates a diagram of an example of converting two-dimensional (2D) coordinates of a plurality of still images into spatial coordinates in a 3D space;

FIG. 6 illustrates an example of a 3D image obtained from a moving image of a tire tread;

FIG. 7 is a flowchart of an example of a method of measuring tire tread abrasion based on a generated 3D image;

FIG. 8 illustrates an example of dividing a 3D image according to a size of a curvature of a pixel;

FIG. 9 illustrates an example of dividing a 3D image into a plurality of sections with reference to a direction and a width of a tread groove area;

FIG. 10 illustrates an example of a 3D image;

FIG. 11 illustrates an example of a method of determining a depth of a tread groove from the 3D image shown in FIG. 10;

FIG. 12 illustrates an example of calibrating a 3D image into a near plane;

FIG. 13 is a block diagram of a terminal for measuring tire tread abrasion, according to an exemplary embodiment;

FIG. 14 is a flowchart of an example of a method of receiving information about tire tread abrasion, the receiving being performed by the terminal, according to an exemplary embodiment; and

FIG. 15 illustrates an example of tire tread abrasion in a related art.

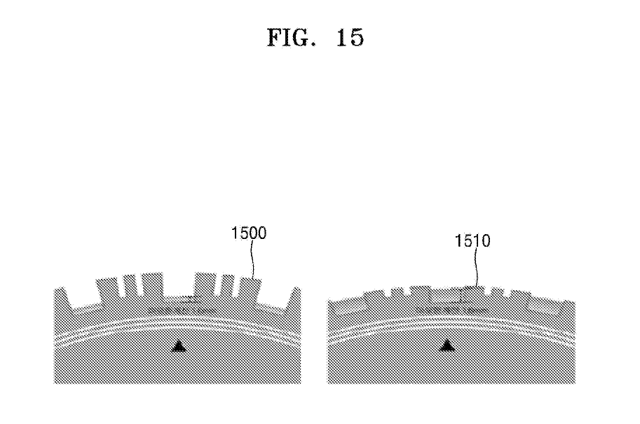

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the exemplary embodiments are merely described below, by referring to the figures, to explain aspects of the present description.

Hereinafter, a method and an apparatus for measuring tire tread abrasion will be described in detail by explaining exemplary embodiments with reference to the attached drawings.

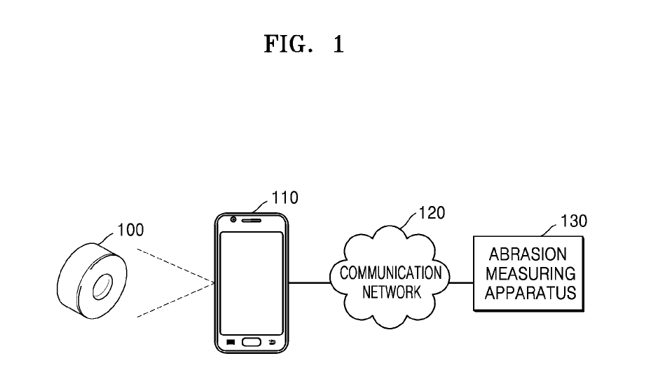

FIG. 1 illustrates a schematic configuration of a system for measuring tire tread abrasion according to an exemplary embodiment.

Referring to FIG. 1, a user captures a moving image of a tire 100 by using a terminal 110. The terminal 110 may be a camera, or a terminal that includes a camera module inside or outside the terminal 110, such as a smartphone, a tablet personal computer (PC), or the like.

In the current embodiment, a moving image is defined as including a plurality of captured still images of an object, as well as a general a moving image. For example, two or more still images which are respectively captured at different locations and combined with each other, as well as a general moving image, are defined as a moving image.

The terminal 110 and an abrasion measuring apparatus 130 are connected to each other, via a wired or wireless communication network 120. For example, if the terminal 110 is a smartphone, the terminal 110 may be connected to the tire recognition apparatus 130 via a mobile communication network such as long term evolution (LTE), 3^{rd} generation (3G), or the like. As another example, if the terminal 110 includes a short-range communication module such as a universal serial bus (USB) port, an infrared communication module, or a Bluetooth module, the terminal 110 may be connected, via a USB port, to a third apparatus (not shown) that may be connected to an external network such as an Internet. A moving image captured by the terminal 110 may be transmitted to the tire recognition apparatus 130 via the third apparatus (not shown).

The tread measuring apparatus 130 measures abrasion of a tire tread by analyzing the moving image received from the terminal 110, and then, provide information about whether to replace a tire or a point of time when the tire is to be replaced to the terminal 110.

In the current embodiment, the abrasion measuring apparatus 130 and the terminal 110 are shown as separate elements. However, the abrasion measuring apparatus 130 may be implemented as software such as an application, stored in the terminal 110, and thus, executed by the terminal 110.

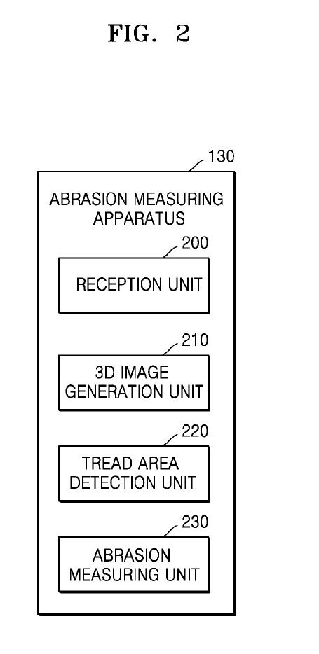

FIG. 2 is a block diagram of the abrasion measuring apparatus 130 according to another exemplary embodiment.

Referring to FIG. 2, the abrasion measuring apparatus 130 includes a reception unit 200, a three-dimensional (3D) generation unit 210, a tread area detection unit 220, and an abrasion measuring unit 230.

The reception unit 200 receives a moving image of a tire tread from the terminal 110. As an example, the reception unit 200 may receive a moving image, captured by the terminal 110, directly from the terminal 110 or via a third apparatus. As another example, if the abrasion measuring apparatus 130 is implemented to be included in the terminal 110, the reception unit 200 may not be included in the tire recognition apparatus 130. If a moving image does not consist of general consecutive images but consists of a plurality of still images that are non-consecutively captured, the reception unit 200 receives a plurality of still images.

The 3D image generation unit 210 generates the received moving image as a 3D image. A 3D image may be generated by using a binocular parallax that is generated from 2D images respectively captured in directions different from each other. Accordingly, the 3D image generation unit 210 divides the moving image into a plurality of still images, and then, generates a 3D image by using a binocular parallax between the plurality of still images.

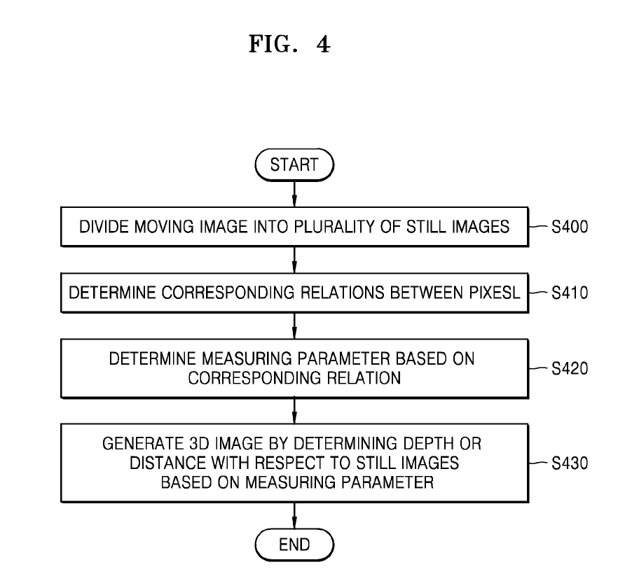

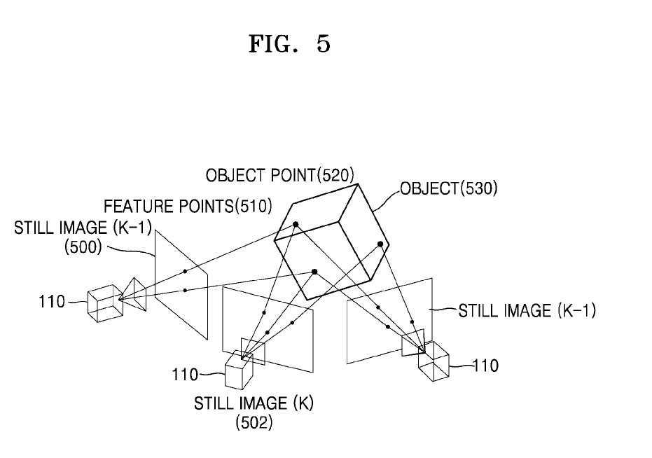

In detail, the 3D image generation unit 210 divides a moving image of a tire tread into a plurality of still images, determine a corresponding relation between pixels of the plurality of still images, determine a photographing parameter regarding a photographing angle at which the moving image is captured and a photographing distance between the camera and the tire based on the determined corresponding relation between the pixels, and thus, generate a 3D image of a tread area. A method of generating a 3D image is described with reference to FIGS. 4 and 5.

As another example, if a moving image received by the reception unit 200 consists of a plurality of still images that are respectively captured, the 3D image generation unit 210 may not perform a process of dividing the moving image into still images.

The tread area detection unit 220 distinguishes a surface area from a tread groove area in a 3d image, and detects the tread groove area and the surface area. For example, since a curvature of an edge between a tread groove area and a surface area in a 3D image is great compared to that of other areas, the tread area detection unit 220 detects an edge area by analyzing a curvature of each pixel of a 3D image, and distinguishes the tread groove area from the surface area with reference to the detected edge area.

The abrasion measuring unit 230 measures tire tread abrasion by determining a depth between the tread groove area and the surface area which are detected by the tread area detection unit 220. As an example, the abrasion detection unit 220 may correct the tread groove area and the surface area in the 3D image to obtain a near plane by using a plane approximation algorithm, and then, determine a depth of a tread groove based on the near plane. As another example, since tire tread abrasion may vary depending on a location of a tread groove, the abrasion measuring unit 230 divides the tread groove area into a plurality of sections, determines a depth of a groove according to each section, and then, measure tire tread abrasion with reference to a section having a deepest groove.

A size of a tire in the 3D image may different from a size of an actual tire. In this case, it may be difficult to accurately measure tire tread abrasion only by using a size of a depth of a tread groove obtained from the 3D image.

For this, the abrasion measuring unit 230 may measure tire tread abrasion by correcting a size of a depth of the tread groove, obtained from a 3D image, to a size of a depth of a tread groove in the actual tire or determining a depth of the tread groove in the 3D image by using a ratio between the depth of the tread groove and a width of a tread in the 3D image.

For example, if a size of a depth of the tread groove in a 3D image is to be corrected to a size of a depth of a tread groove in an actual tire, the abrasion measuring unit 230 corrects the depth of the tread groove in the 3D image in correspondence with a proportional size relationship between a width of a tread or a space between treads in the actual tire and a width of a tread or a space between treads in the 3D image.

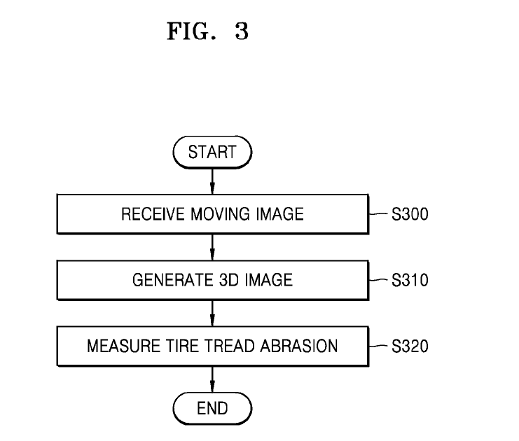

FIG. 3 is a flowchart of an example of a method of measuring tire tread abrasion according to an exemplary embodiment.

Referring to FIG. 3, in operation S300, the abrasion measuring apparatus 130 obtains a moving image of a tire tread. In operation S310, the tire abrasion measuring apparatus 130 generates a 3D image of an area of the tire tread by using the moving image of the tire. Then, in operation S320, the abrasion measuring apparatus 130 measures tire tread abrasion by determining a depth of a tread groove from the 3D image.

FIG. 4 is a flowchart of an example of a method of generating a 3D image by using a moving image so as to measure tire tread abrasion. FIG. 5 illustrates an example of converting two-dimensional (2D) coordinates of a plurality of still images into spatial coordinates in a 3D space.

Referring to FIG. 4, in operation S400, the abrasion measuring apparatus 130 divides a moving image into a plurality of still images. In operation S410, the abrasion measuring apparatus 130 determines a corresponding relation between pixels of a plurality of still images. For example, referring to FIG. 5, if pixels at a particular location of images of an object which are captured by the terminal 110 at different locations from each other, that is, a pixel P_{j,k-1} of a k-1th still image 500, a pixel P_{j,k} of a kth still image 502, and a pixel P_{j,k+1} of a k30 1th still image correspond to each other, the abrasion measuring apparatus 130 calculates and stores a corresponding relation between the respective pixels. This is generally referred to as stereo matching. In the current embodiment, various methods of determining a matching relation between pixels of still images by determining feature points 501 of the still images, in a related art, may be employed.

In operation S420, the abrasion measuring apparatus 130 calculates a relative relation between the plurality of still images and locations of the terminal 110 (that is, a camera used for the terminal 110) when each still image is captured, based on a corresponding relation between respective pixels of a plurality of still images. In other words, the abrasion measuring apparatus 130 reversely calculates a measuring parameter, for example, a focal length, a photographing angle, a location of a camera, or the like at which the plurality of still images are captured, based on a corresponding relation between pixels of a plurality of still images.

In operation S430, the abrasion measuring apparatus 130 determines points corresponding to spatial coordinates of each pixel in a 3D space by using a triangulation method based on a binocular parallax between the pixels of the plurality of still images, and a photographing direction in which the terminal 110 captures the moving image and a photographing location in which the terminal 110 captures the moving image with respect to the plurality of still images, and generates an image in a 3D space by combining the points corresponding to the spatial coordinates with each other.

For example, referring to FIG. 5, the abrasion measuring unit 130 may determine the respective pixels P_{j,k-1}, P_{j,k}, and P_{j,k+1} corresponding to the feature points 501 in the k-1th still image 500, the kth still image 502, and the k+1th still image, determine a photographing location in which the terminal 110 captures the moving image and a photographing angle at which the terminal 110 captures the moving image with respect to each still image, and then, obtain spatial coordinates 520 by determining points in a space corresponding to the respective pixels by using a triangulation method. A 3D image is generated by connecting the points in the space which corresponds to the spatial coordinates 520 to each other.

If a moving image of a tire tread is captured, a location in which the terminal 110 captures the moving image may be moved. Thus, a plurality of still images in the moving image, obtained when the location in which the terminal 110 captures the moving image is moved, have binocular parallax. FIG. 4 is a flowchart of an example of a method of generating a 3D image from a plurality of still images which are included in a moving image and have a binocular parallax. However, exemplary embodiments are not limited to the method described with reference to FIG. 4, and various methods of generating a 3D image in a related art may be employed.

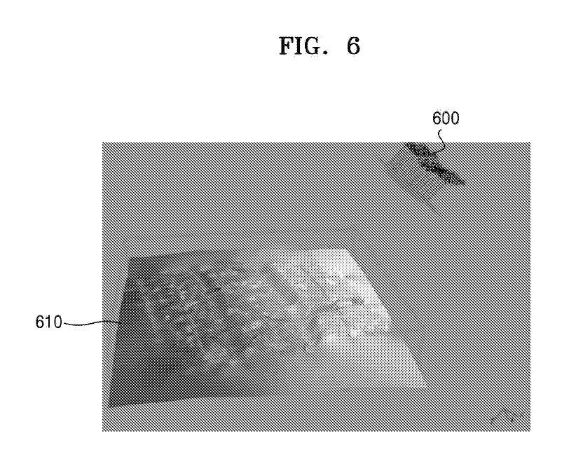

FIG. 6 illustrates an example of a 3D image obtained from a moving image of a tire tread.

Referring to FIG. 6, the abrasion measuring apparatus 130 may divide a moving image into a plurality of still images, determine a relative location of a camera with respect to the plurality of still images and an angle at which the camera captures the plurality of still images, and thus, obtain the plurality of still images having a binocular parallax, like being photographed by a plurality of cameras 600.

The abrasion measuring apparatus 130 generates a 3D image 610 of an area of a tire tread based on the plurality of still images having a binocular parallax.

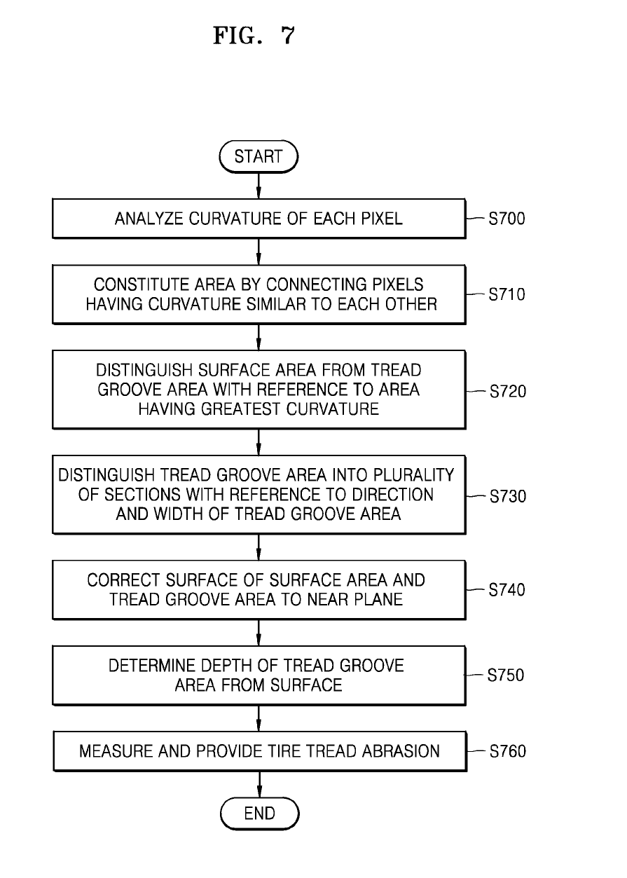

FIG. 7 is a flowchart of an example of a method of measuring tire tread abrasion based on a generated 3D image.

Referring to FIG. 7, if the abrasion measuring apparatus 130 obtains a 3D image shown in FIG. 6, the abrasion measuring apparatus 130 analyzes a curvature of each pixel in the 3D image in operation S700.

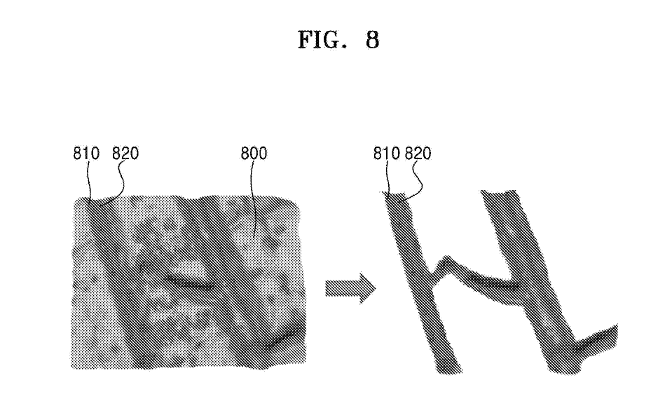

In operation S710, the abrasion measuring apparatus 130 connects pixels, which have a size of a curvature similar to each other and whose distance from each other is within a certain range, to each other. An example of showing areas, distinguished from each other according to a size of a curvature of each pixel, in a color different from each other is shown in FIG. 8. A range of a size of a curvature for distinguishing areas from each other may be variously set according to exemplary embodiments.

For example, if pixels having a size of a curvature greater than a predetermined threshold value are connected to each other, an edge area 810 between a surface area and a groove area is detected in a 3D image. Additionally, if pixels having a value of a curvature approximating to 0 are connected to each other, the surface area and the groove area which are in the form of a plane are detected.

However, if areas are distinguished from each other by using a size of a curvature for each pixel in a 3D image, small noise areas may occur as shown in FIG. 8. Since sizes of such noise areas are very small compared to sizes of a surface area, a groove area, or an edge area, the noise areas may be removed by performing a process of removing areas having a smaller size that a predetermined size. In other words, as shown in FIG. 8, all areas that occur on the surface area and have a smaller size that a certain size may be absorbed into large areas to obtain a smooth plane.

In operation S720, the abrasion measuring apparatus 130 distinguishes a groove area 820 from a surface area 800 with reference to an area having a greatest curvature, that is, an edge area 810.

The abrasion measuring apparatus 130 may directly obtain tire tread abrasion based on a depth of the tread groove area 820. However, in operation S730, the abrasion apparatus 130 divides the tread groove area into a plurality of sections by taking into account that the tire tread abrasion may vary depending on a location in the tread groove area 820 at which the tire tread abrasion is measured.

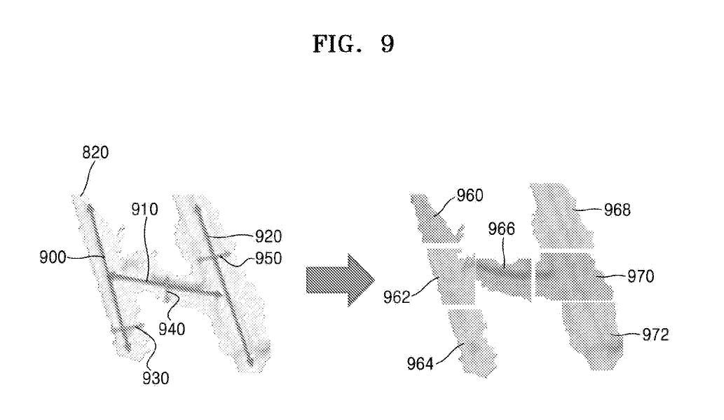

Various methods of dividing a tread groove area into a plurality of sections may be present. As an example, referring to FIG. 9, the tread groove area 820 may be divided into a plurality of sections with reference to a direction and a width of the tread groove area 820. In detail, the abrasion measuring apparatus 130 determines center axes 900 through 920 with respect to a direction of the tread groove area 820, and determines a width of each tread groove based on direction vectors 930 through 950 perpendicular to the center axes 900 through 920. Additionally, the abrasion measuring apparatus 130 may divide the tread groove area 820 into a plurality of sections 960, 962, 964, 966, 968, 970, and 972 with reference to the direction and the width of the tread groove area 820.

For example, with respect to a width of a tread groove in a direction perpendicular to the center axis 900 which is shown on a left side in FIG. 9 since a center area of the tread groove is larger than other areas, the tread groove may be divided into three parts 960, 962, and 964 with reference to the width thereof. Other areas may also be divided into small parts with reference to a width, or the like. Other various methods of dividing the tread groove area 820 into small parts in the units of a certain size of area or a certain length may be also used.

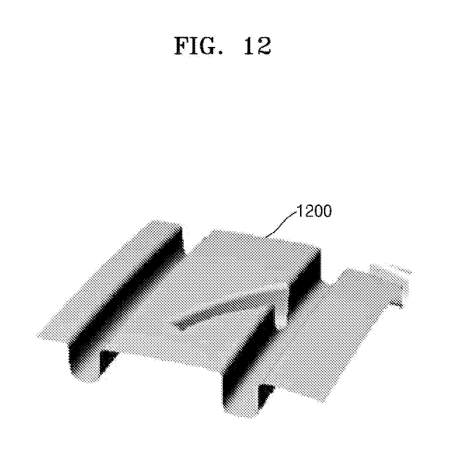

The abrasion measuring apparatus 130 may correct the tread groove area 820 and the surface area 800 to obtain a near plane. For example, referring to FIG. 12, the abrasion measuring apparatus 130 may correct surfaces of a tread groove area and a surface area to obtain a near plane 1200 by using a plane approximation algorithm such as a least squares fitting method.

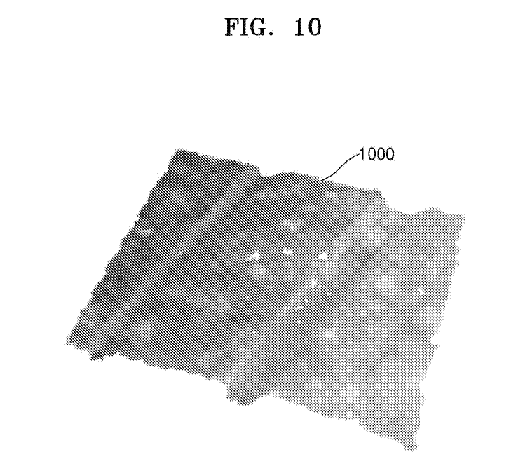

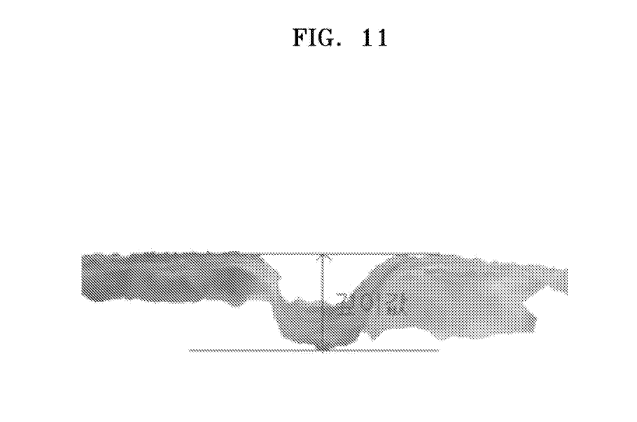

In operation S750, the abrasion measuring apparatus 130 determines a depth of the tread groove area 820 based on the surface area 800. For example, if a surface area and a tread groove area of a 3D image are distinguished from each other as shown in FIG. 10, a depth of a groove may be determined from a surface as shown in FIG. 11. Alternately, a depth of a groove may be determined by determining a depth of the edge area 810 that distinguishes the surface area 800 from the tread groove area 820. If the near plane 1200 is obtained as shown in FIG. 12, a depth of a groove area may be determined based on the near plane 1200. Additionally, if tread groove area 820 is divided into the plurality of sections 960, 962, 964, 966, 968, 970, and 972, a depth of the tread groove area 820 may be determined for each section, and then, a depth of a deepest location of the groove area may be determined as a depth of a groove of a tire tread.

The abrasion measuring apparatus 130 determines a degree of tire tread abrasion based on a depth of the tread groove area. Then, in operation S760, the abrasion measuring apparatus 130 may calculate and provide information about whether to replace a tire or a point of time when a tire is to be replaced to the terminal 110. Since a size of a tire in a 3D image and a size of an actual tire are in a certain proportional relation, the abrasion measuring apparatus 130 may measure tire tread abrasion by using a depth of a groove obtained by correcting a tire in a 3D image to an actual tire, instead of using a depth of a groove in the 3D image.

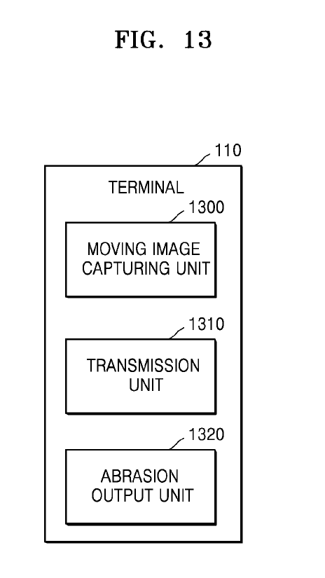

FIG. 13 is a block diagram of the terminal 110 for measuring tire tread abrasion, according to an exemplary embodiment.

Referring to FIG. 13, the terminal 110 includes a moving image capturing unit 1300, a transmission unit 1310, and an abrasion output unit 1320.

The moving image capturing unit 1300 captures a moving image of a tire. Like a camcorder, the moving image capturing unit 1300 may capture a moving image consisting of consecutive images or capture a plurality of still images.

The transmission unit 130 transmits the captured moving image to the abrasion measuring apparatus 130.

The abrasion output unit 1320 receives various information about abrasion such as a degree of abrasion, whether to replace a tire, or a point of time when a tire is to be replaced from the abrasion measuring apparatus 130, and outputs the information.

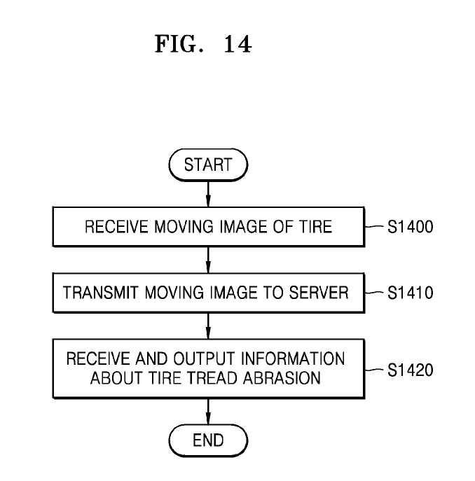

FIG. 14 is a flowchart of an example of a method of receiving information about tire tread abrasion, the receiving being performed by the terminal 110, according to an exemplary embodiment.

Referring to FIG. 14, the terminal 110 captures a moving image of a tire in operation S1400, and then, transmits the moving image to the abrasion measuring apparatus 130 in operation S1410. In operation S1420, the terminal 1100 receives information about tire tread abrasion from the abrasion measuring apparatus 130, and outputs the information.

According to one or more exemplary embodiments, the method and the apparatus for measuring tire tread abrasion may allow a user to easily determine tire tread abrasion by capturing a moving image of a tire by using a camera included in a smartphone or the like, without having to measure a depth of a tread groove of a tire. Additionally, the method and the apparatus may indicate a point of time when the tire needs to be replaced. Additionally, if it is time to replace a tire, the method and the apparatus may also indicate a point of time when the tire needs to be replaced and information about the tire together.

Exemplary embodiments can also be embodied as computer-readable codes on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope of the inventive concept as defined by the following claims.

What is claimed is:

1. A method of measuring tire tread abrasion, the method comprising:
receiving a moving image of a tire;
generating a three-dimensional (3D) image of the tire based on the moving image; and
measuring tire tread abrasion based on a depth of a tread area in the 3D image,
wherein the generating of the 3D image comprises:
dividing the moving image into a plurality of still images;
determining a corresponding relation between respective pixels of the plurality of still images;
determining a parameter that includes an angle at which the moving image is captured and a photographing distance between a camera and the tire, which are used when the moving image is captured, based on the corresponding relation between the respective pixels; and
generating a 3D image of the tire by determining depth information about the plurality of still images based on the parameter.

2. A method of measuring tire tread abrasion, the method comprising:
receiving a moving image of a tire;
generating a three-dimensional (3D) image of the tire based on the moving image; and
measuring tire tread abrasion based on a depth of a tread area in the 3D image,
wherein the measuring of the tire tread abrasion comprising:
detecting a tread groove area and a surface area based on curvature analysis of the 3D image;
determining a depth of the tread groove area based on the detected surface area; and
recognizing the tire tread abrasion based on the determined depth.

3. The method of claim 2, wherein the detecting of the tread groove area and the surface area comprises:
analyzing a curvature of each pixel of the 3D image;
determining an area having a greatest curvature from among areas generated by connecting pixels, which have a size of a curvature similar to each other and whose distance from each other is within a certain range from each other, to each other; and
detecting a tread groove area and a surface area which are divided with reference to the area having the greatest curvature.

4. The method of claim 2, wherein the determining of the depth of the tread groove area comprises:
dividing the tread groove area into a plurality of one section; and
determining a depth in each of the plurality of sections.

5. The method of claim 4, wherein the dividing of the tread groove area into the plurality of one section comprises:
determining a direction of the tread groove area;
determining a width of the tread groove area based on a direction vector perpendicular to the direction of the tread groove area; and
dividing the tread groove area into a plurality of sections based on a direction and a width of the tread groove area.

6. The method of claim 2, wherein the determining of the depth of the tread groove area comprises:
correcting the tread groove area and the surface area to a plane by applying a plane approximation algorithm to the tread groove area and the surface area; and
determining a depth of the tread groove area based on the plane obtained by the correcting.

7. The method of claim 3, wherein the determining of the depth of the tread groove area comprises:
correcting the tread groove area and the surface area to a plane by applying a plane approximation algorithm to the tread groove area and the surface area; and
determining a depth of the tread groove area based on the plane obtained by the correcting.

8. The method of claim 4, wherein the determining of the depth of the tread groove area comprises:
correcting the tread groove area and the surface area to a plane by applying a plane approximation algorithm to the tread groove area and the surface area; and
determining a depth of the tread groove area based on the plane obtained by the correcting.

9. The method of claim 5, wherein the determining of the depth of the tread groove area comprises:
correcting the tread groove area and the surface area to a plane by applying a plane approximation algorithm to the tread groove area and the surface area; and
determining a depth of the tread groove area based on the plane obtained by the correcting.

10. A non-transitory computer-readable recording storage medium having recorded thereon a computer program which, when executed by a computer, performs the method of claim 1.
